(19) United States
(12) Patent Application Publication
(10) Pub. No.: US 2020/0063344 A1
(43) Pub. Date: Feb. 27, 2020

(54) Seam for Endless Fabric Belt

(71) Applicant: ASTENJOHNSON, INC., Charleston, SC (US)

(72) Inventors: Rae Patel, Neenah, WI (US); Chad Aaron Martin, Appleton, WI (US)

(21) Appl. No.: 16/093,903

(22) PCT Filed: Sep. 14, 2017
(86) PCT No.: PCT/IB2017/055569

§ 371 Date: Oct. 15, 2018

Related U.S. Application Data
(60) Provisional application No. 62/394,507, filed on Sep. 14, 2016.

(51) Int. Cl. D21F 1/00; B29C 65/16; B29C 65/00

(52) U.S. Cl. CPC D21F 1/0054; B29C 65/1635; B29L 2031/709; B29C 66/71; B29C 66/729; B29C 66/21

(57) ABSTRACT

An endless fabric belt having a seam region, the seam region comprising: a) machine direction (MD) threads; b) cross-direction (CD) threads interwoven with the MD threads; and c) termination zones distributed throughout the entire seam region, with each termination zone comprising two ends of an MD thread; wherein: a plurality of the CD threads are fusible, with the fusible (F) and non-fusible (N) CD threads distributed in a pattern throughout the seam region such that in a repeating unit of the pattern, the ratio of F threads to CD threads is at most 0.75; and a plurality of the termination zones further comprise at least one fusible CD thread attached to the MD thread in the termination zone.

### TECHNICAL FIELD

This disclosure relates to the field of endless fabric belts. In particular, it relates to seams of such belts.

### BACKGROUND

In modern high speed papermaking processes, a highly aqueous stock consisting of about 99% water and 1% papermaking solids is ejected at high speed and precision onto an endless moving forming fabric. A nascent web, which will be self coherent and consist of up to about 20% papermaking solids by the end of the forming section, is formed as the stock is drained through the fabric. This web is then transferred from the forming fabric into the press section where, together with at least one press fabric, it passes through one or more nips where additional fluid is removed by mechanical means. The web is then transferred into the dryer section of the papermaking machine where much of the remaining moisture is removed by evaporative means, the web being supported on one or more dryer fabrics as it is heated, for example by being passed in serpentine fashion over a series of heated rotating drums. The finished sheet is then reeled into large rolls at the end of the papermaking machine, and further finishing processes may be applied.

Forming fabrics are critical to the quality of the paper product that is ultimately produced on the papermaking machine. In simplest terms, these fabrics are designed to allow fluid from the stock to drain through the fabric in a controlled manner, while providing uniform support to the papermaking solids.

Many towel and tissue products are presently manufactured using a through-air drying (TAD) process. In the TAD process, the wet web is formed by depositing a papermaking furnish onto a moving forming fabric where it is initially drained, and then transferring the resulting very wet web onto a TAD fabric, which is generally of a very open and permeable design. The TAD fabric is directed around a permeable drum where the sheet is non-compressively dried by passing hot air through the drum and web while it is held in intimate contact with the fabric. The product may then pass over a subsequent Yankee dryer, which is essentially a large steam cylinder with a polished surface, or the Yankee may be omitted.

Both forming fabrics and TAD fabrics are typically flat woven from polymeric threads or monofilaments, and the ends of a length of the woven fabric are then joined together by a seam in order to form an endless loop. The seams may be formed by unweaving and reweaving the ends of the threads forming the fabric together so that there are no, or only limited, discontinuities in the fabric and its properties at the seam. This leaves terminations of the machine direction (MD) threads, typically directed to the machine side of the fabric.

Papermaking machines operate at high speeds with tensions that oscillates causing MD oriented tensile stress. The seam of a fabric is typically weaker than the body of the fabric and is therefore more easily affected by the stress while the machines are in operation. While under tension the MD thread terminations may slip from their original position enough to either protrude past the papermaking surface causing damage to the product being made or to separate far enough from their original position that a seam failure occurs and the entire fabric splits apart in the cross-machine (CD) direction.

Traditional methods of seaming forming and TAD fabrics rely on friction to keep the seam together as the MD and CD threads cross each other in the seam area. More recently it has become known in the art of papermaking fabrics to fuse threads together, particularly through the use of laser welding thermoplastic materials, in order to obtain improved seam strength and reduced movement of seam terminations.

U.S. Pat. No. 8,062,480 discloses a process for producing papermaker's and industrial fabric seam, and a seam produced by the process. Laser energy is used to weld or melt certain points in industrial fabrics.

US 20150096704 discloses a stabilized woven seam for flat-weave endless fabric belts, which includes machine-direction (MD) threads and cross-machine-direction (CD) threads. The fabric belt has two ends that are connected in a seam region by bringing together end sections of the MD threads in pairs which form junction points. These MD threads are also woven with CD threads in the seam region. Part of the threads includes threads that are made of a thermoplastic polymer material which is transparent to light of a certain range of wavelengths (i.e. laser). In the seam region, a bond is formed at thread contact points by absorption of laser energy. In the seam region, a plurality of spaced-apart, strip-shaped fabric sections are formed in the following pattern: one strip-shaped fabric section without junction points is formed between two adjacent fabric sections having junction points.

US 20130333792 A1 discloses a stabilized fabric seam for flat-woven continuous fabric belts having intersecting threads. Within the fabric seam region, there are at least two strip-shaped regions which extend over the entire width of fabric seam and contain meeting points. These points are arranged between the strip-shaped regions in which there are crossovers between MD and CD threads. The crossovers are connected by transmission welding.

US 20070028997 A1 discloses a forming fabric for use in a paper machine, along with a method and apparatus for manufacturing the forming fabric. In order to increase stability, crossing threads are engaged with one another at crossing points and in which some of the threads are fused to one another. The latter is accomplished by the fact that in crossing first and second threads, the first threads absorb laser energy such that their surface melts, and subsequently the first and second threads are fused to one another.

Uniformity of air permeability and fabric contact with the TAD roll on a micro scale is desirable to ensure that heat transfer and drying are uniform throughout the paper web. This requires the fabric to have uniform air permeability and flexibility in both the machine and cross-machine direction. Fusing threads in concentrated areas may cause localized discontinuities in the fabric air permeability and flexibility which may cause marking of the paper due to differences in air flow or heat transfer. Similarly, fusing threads throughout the entire seam area, or in dense sections throughout the seam, could also result in undesirable sheet defects as well as runnability issues due to sudden changes in fabric shear properties.

Another important fabric property to maintain is uniformity of fabric shear modulus in the plane of the fabric. Shear modulus is a measure of the ability to resist distortion in the fabric XY plane when a shear load is applied.

It is important to provide a fabric with a seam area that retains fabric characteristics, specifically air permeability and caliper. This should be achieved while also providing uniformity of stiffening, particularly no concentrated areas of high or low stiffness.

What is needed is an optimum placement of fusible threads throughout the seam so as to improve seam strength while preventing sheet defects and allowing for adequate flexibility and consistency of features with the body of the fabric.

### SUMMARY

The seam for an endless belt fabric in its general form will first be described, and then its implementation in terms of embodiments will be detailed hereafter. These embodiments are intended to demonstrate the principles of the reinforced element, and the manner of implementation. The seam in the broadest and more specific forms will then be further described, and defined, in each of the individual claims which conclude this specification.

In one aspect of the present disclosure, there is provided an endless fabric belt having a seam region, the seam region comprising: machine direction (MD) threads; cross-direction (CD) threads interwoven with the MD threads; and termination zones distributed throughout the entire seam region, with each termination zone comprising two ends of an MD thread; wherein: a plurality of the CD threads are fusible, with the fusible (F) and non-fusible (N) CD threads distributed in a pattern throughout the seam region such that in a repeating unit of the pattern, the ratio of F threads to CD threads is at most 0.75; and a plurality of the termination zones further comprise at least one fusible CD thread attached to the MD thread in the termination zone. Alternatively, the ratio of F threads to CD threads in the repeating unit may be at most 2:3. It is noted that one or more of the termination zones comprise a fusible CD thread attached to an MD thread. The termination zone may include weaving of the ends of the MD thread with CD threads. If there are termination zones without such an attachment, then the two ends of the MD thread are mechanically attached through weaving with CD threads in the seam region.

The CD threads may be fusible based on laser-weld technology, low-melt polymer technology, sheath-core technology or ultrasonic technology.

The MD and CD threads may independently comprise a polymeric material. For example, the polymeric material may be a polyamide or a polyethylene terephthalate. Examples include polyphenylene sulfide (PPS), polybutylene terephthalate (PBT), polyurethane, and polyethylene naphthalate (PEN).

Where the CD threads are fusible by laser-weld technology, the fusible CD thread further comprises an additive, which may be added in a range of from about 0.1 wt % to about 3 wt % of the weight of the CD thread. Alternatively, the additive may be added in a range of from about 0.3 wt % to about 1 wt % of the weight of the CD thread.

As an example, where the CD threads are fusible based on laser-weld technology, a plurality of the CD threads are fusible in a wavelength range of laser; the MD threads are transparent to light of the wavelength range; and at least some of the MD threads are laser-welded to the fusible CD threads by the laser. Furthermore, the fusible CD threads may comprise carbon, in the form of graphite, carbon black, or carbon nanotubes. In an example, the fusible CD threads comprise carbon black.

In an embodiment, there is at least one non-fusible CD thread in between two fusible CD threads in the repeating unit of the pattern. The seam region can be a single layer weave or a multilayer weave. Where the seam region is a single layer weave, the unit pattern of the CD threads may range anywhere from three fusible (F) threads per one non-fusible (N) thread, to one fusible (F) thread per a non-limiting number of non-fusible (N) threads. Examples of the CD unit pattern include FN (one fusible CD thread per two CD threads), FNN (one fusible CD thread per three CD threads), FNFNNN (two fusible CD threads per six CD threads), and FFNNNFFNNNN (four fusible CD threads per eleven CD threads). Other patterns are also possible.

Where the seam region is a multilayer weave, the overall unit pattern of the CD threads may range anywhere from three fusible (F) threads per one non-fusible (N) thread, to one fusible (F) thread per a non-limiting number of non-fusible (N) threads. Examples of the CD unit pattern include (one fusible CD thread per six CD threads), FN (one fusible CD threads per eight CD threads) and F (one fusible CD threads per twelve CD threads). Other patterns are also possible.

The foregoing summarizes the principal features of the seam and some optional aspects thereof. The seam may be further understood by the description of the embodiments which follow.

Wherever ranges of values are referenced within this specification, sub-ranges therein are intended to be included within the scope of the seam unless otherwise indicated. Where characteristics are attributed to one or another variant of the seam unless otherwise indicated, such characteristics are intended to apply to all other variants where such characteristics are appropriate or compatible with such other variants.

### BRIEF DESCRIPTION OF FIGURES

FIG. 1 illustrates a plan view of one embodiment of a seam.

FIG. 1b illustrates an enlarged portion of the seam shown in FIG. 1.

FIG. 2 illustrates a second view of the embodiment shown in FIG. 1.

FIG. 3 illustrates successive warp paths of the embodiment shown in FIG. 2.

FIG. 4 illustrates a plan view of another embodiment of a seam.

FIG. 5 illustrates a second view of the embodiment shown in FIG. 4.

FIG. 6 illustrates successive warp paths of the embodiment shown in FIG. 5.

FIG. 7 illustrates successive warp paths of another embodiment of a seam.

FIG. 8 illustrates successive warp paths of another embodiment of a seam.

FIG. 9 illustrates another embodiment of a single layer seam region.

FIG. 10 illustrates another embodiment of a single layer seam region.

FIG. 11 illustrates another embodiment of a seam region.

FIG. 12 illustrates an embodiment of a multilayer seam region.

FIG. 13 illustrates another embodiment of a multilayer seam region.

FIG. 14 illustrates another embodiment of a multilayer seam region.

FIG. 15 illustrates another embodiment of a multilayer seam region.

FIG. 16 illustrates another embodiment of a single layer seam region.

### DETAILED DESCRIPTION

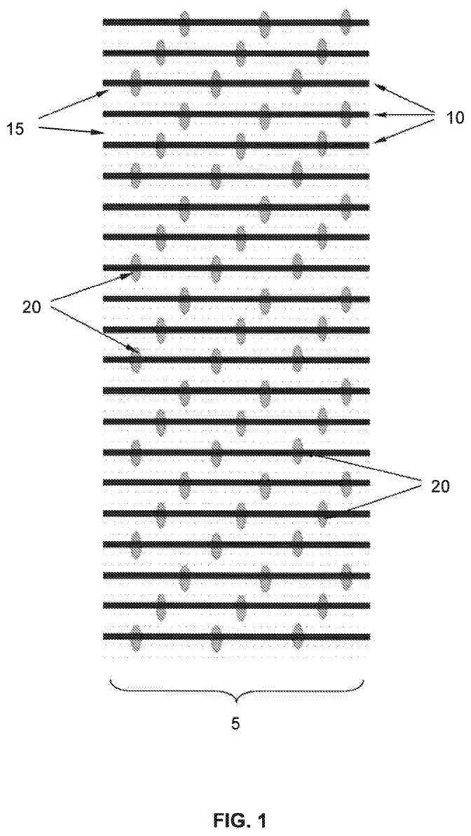

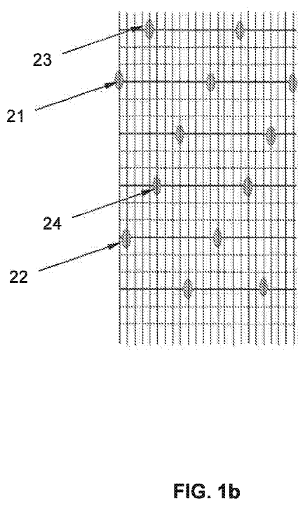

FIG. 1 illustrates a plan view of one embodiment of a seaming region (5) that is comprised of CD threads (10, 15) and MD threads (not shown). The MD threads connect at termination zones (20) throughout the seaming region (5). The CD threads are of two types: fusible (F,10) and non-fusible (N,15). As shown, the fusible (10) and non-fusible (15) CD threads are arranged in a pattern throughout the seam region (5). In this embodiment, the repeating pattern unit is “FNN”—that is, one fusible thread (10) followed by two non-fusible threads (15). Other patterns of F- and N-type CD threads are also possible, and a few other examples are discussed below. Furthermore, as shown in FIG. 1, the termination zones (20) are distributed throughout the entirety of the seam region (5). In this embodiment, the termination zones (20) are distributed throughout the seam region (5) in a pattern as well; i.e. the termination zones (20) are evenly spaced apart throughout. It should be noted that the termination zones (20) can be distributed throughout the seam region (5) in a random manner, so long as the termination zones (20) are distributed through the entire seam region (5).

FIG. 1b illustrates an enlarged portion of the seam shown in FIG. 1, to clearly show that the termination zones are not aligned in the MD direction, but, instead, are offset in the CD direction.

For example, in the illustration shown in FIG. 1b, termination zone 22 is offset by one MD thread from termination zone 21. In addition, there are 8 CD threads (in the sequence NNFNNFNN) between successive termination zones 21 and 22. Similarly to successive termination zones 21 and 22, successive termination zone 23 is offset by one MD thread from termination zone 24, with 8 CD threads between termination zones 23 and 24. Note that termination zone 23 is offset by three MD threads from termination zone 22, with 11 CD threads (in the sequence NNFNNFNNFNN) between successive termination zones 22 and 23. There are other possible alignments of the termination zones in the seam region.

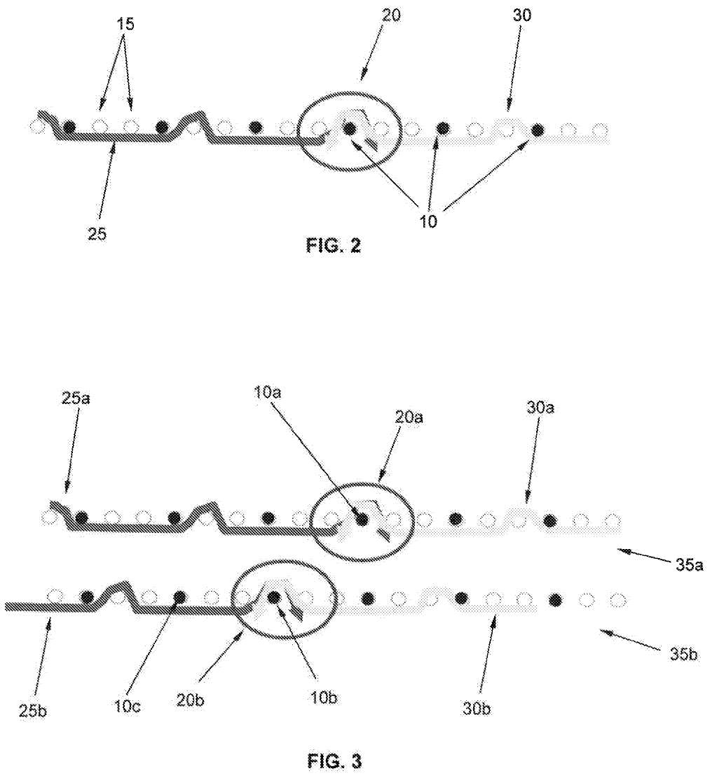

FIG. 2 illustrates a second view of the embodiment shown in FIG. 1, in which two ends of an MD thread (25, 30) are woven through CD threads (10, 15), and meet at a termination zone (20). The fusible (10) and non-fusible (15) CD threads are arranged in the FNN repeat pattern shown in FIG. 1. In this embodiment, the termination zone (20) occurs at fusible CD thread (10), where the two ends of the MD thread (25, 30) cross over and are attached to the fusible CD thread (10). As an example, if laser welding is used to connect the two ends of the MD thread (25, 30) to the fusible CD thread (10) at termination zone (20), the two ends of the MD thread (25, 30) are transparent to the wavelength of the laser used for laser welding, whereas the fusible CD thread (10) absorbs energy in the wavelength range of the laser used in laser welding. While FIG. 2 shows each end of an MD thread (25, 30) terminating not far beyond termination zone (20), it is understood that one or both ends of MD threads (25, 30) can extend beyond termination zone (20) to mechanically weave with CD threads (10, 15).

FIG. 3 illustrates successive warp paths (35a, 35b) of the embodiment shown in FIG. 2. In this figure, the CD threads and MD threads are as in FIG. 2, in that the fusible (10) and non-fusible (15) CD threads are arranged in a FNN repeat pattern. In warp path (35a), the termination zone is at (20a), where MD thread ends (25a, 30a) cross over and are connected to CD fusible thread (10a). In the adjacent warp path (35b), the termination zone is at (20b), where MD thread ends (25b, 30b) cross over and are connected to CD fusible thread (10b). As can be seen, the termination zones (20a, 20b) in successive warp paths (35a, 35b) are separated by two successive non-fusible CD threads, for the FNN pattern shown. Other termination zone patterns are possible for the FNN pattern. For example, successive termination zones can occur at CD fusible threads (10a) and (10c), instead of (10a, 10b). In this case, the termination zones would be separated by five CD threads (with a NNFNN sequence).

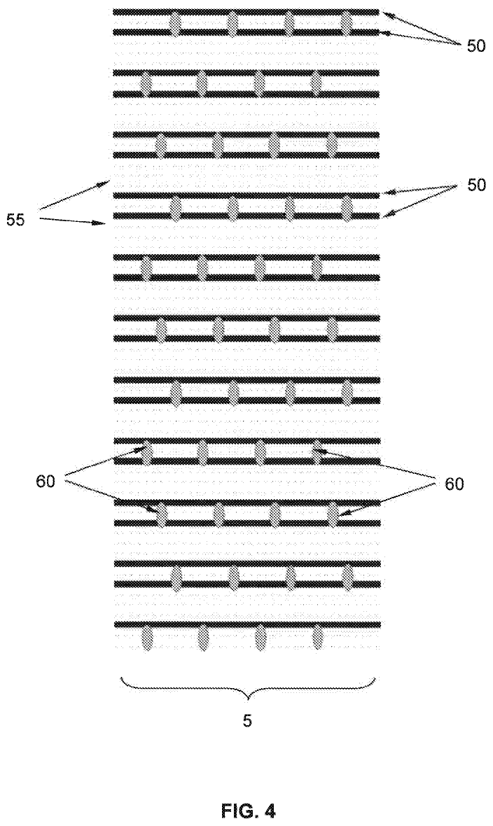

FIG. 4 illustrates a plan view of another embodiment of a seaming region (5) that is comprised of CD threads (50, 55) and MD threads (not shown). The MD threads connect at termination zones (60) throughout the seaming region (5). The CD threads are of two types: fusible (F,50) and non-fusible (N,55). As shown, the fusible (50) and non-fusible (55) CD threads are arranged in a pattern throughout the seam region (5). In this embodiment, the repeating pattern unit is “FNFNNN”. Furthermore, as shown in FIG. 4, the termination zones (60) are distributed throughout the entirety of the seam region (5) in a pattern in which the termination zones (60) are evenly spaced apart throughout. It should be noted that the termination zones (60) can be distributed throughout the seam region (5) in a random manner, so long as the termination zones (60) are distributed through the entire seam region (5).

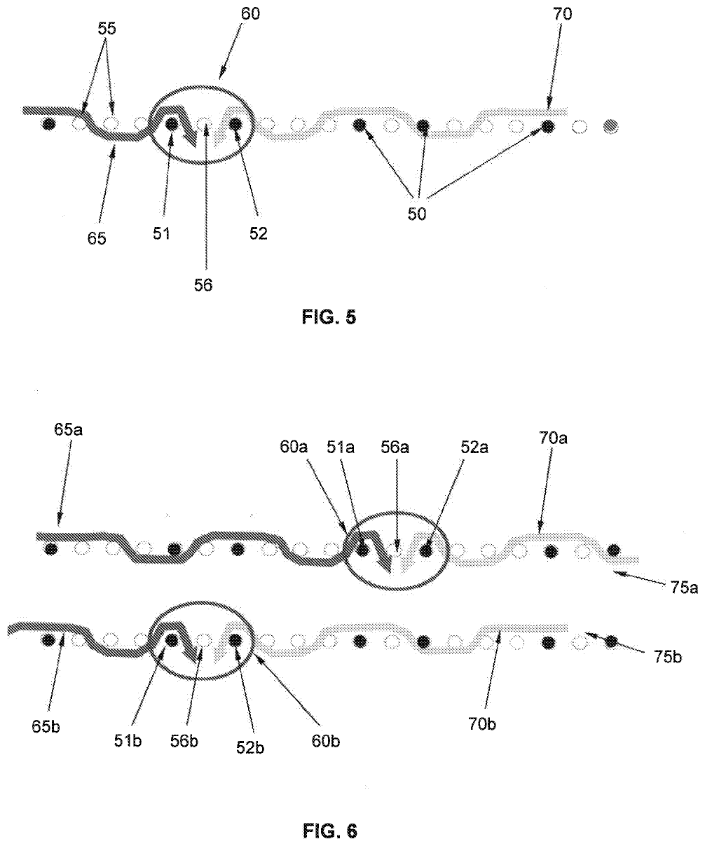

FIG. 5 illustrates a second view of the embodiment shown in FIG. 4, in which two ends of an MD thread (65, 70) are woven through CD threads (50, 55), and meet at a termination zone (60). The fusible (50) and non-fusible (55) CD threads are arranged in the FNFNNN repeat pattern shown in FIG. 4. In this embodiment, the termination zone (60) occurs over a breadth of three CD threads (51, 52, 56). Here, the two ends of the MD thread (65, 70) are attached to two fusible CD threads (51, 52), with a non-fusible CD thread (56) in between the two CD fusible threads (51, 52). While FIG. 5 shows each end of the MD thread (65, 70) terminating without crossing over, it is possible for one or both ends of the MD thread (65, 70) to continue weaving with non-fusible CD thread (56) and beyond. As an example, if laser welding is used to connect the ends of the MD thread (65, 70) to the fusible CD threads (51, 52) at termination zone (60), the ends of the MD thread (65, 70) are transparent to the wavelength of the laser used for laser welding, whereas the fusible CD threads (51, 52) absorb energy in the wavelength range of the laser used in laser welding.

FIG. 6 illustrates successive warp paths (75a, 75b) of the embodiment shown in FIGS. 4 and 5. In this figure, the CD threads and MD threads are as in FIG. 5. In warp path (75a), the termination zone is at (60a) and occurs over a distance of three CD threads (51a, 52a, 56a). The two ends of the MD thread (65a, 70a) are attached to two CD fusible threads (51a, 52a), with a non-fusible CD thread (56a) in between the two CD fusible threads (51a, 52a). In the adjacent warp path (75b), the termination zone is at (60b) and occurs over a distance of three CD threads (51b, 52b, 56b). The two ends of the MD thread (65b, 70b) are attached to two CD fusible threads (51b, 52b), with a non-fusible CD thread (56b) in between the two CD fusible threads (51b, 52b). As can be seen, the termination zones (60a, 60b) in successive warp paths (75a, 75b) are separated by three successive non-fusible CD threads, for the FNFNNN pattern shown. Other termination zone patterns are possible for the FNFNNN pattern. For example, successive termination zones can have nine successive CD threads (in the sequence NNNFNFNNN) in between.

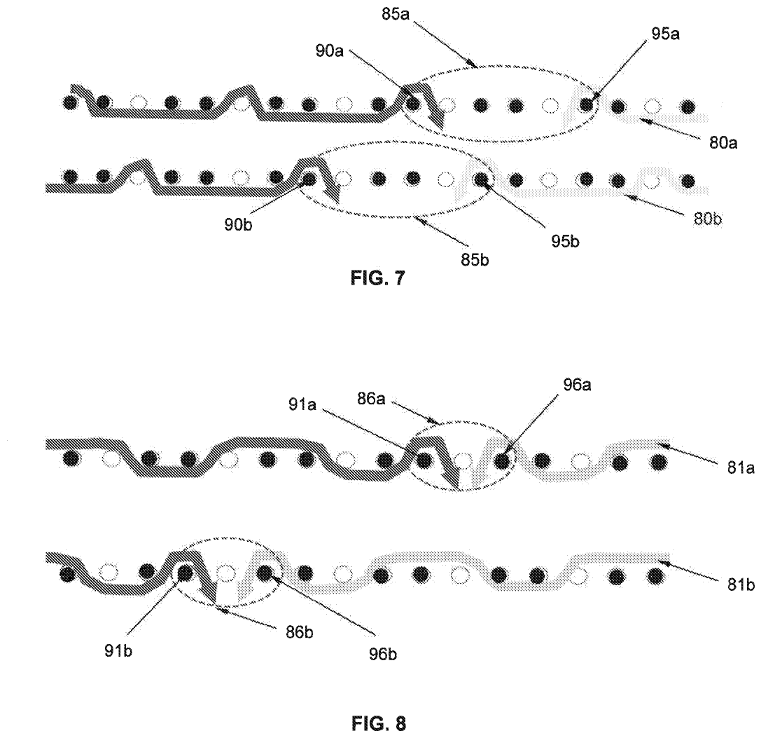

FIG. 7 illustrates successive warp paths (80a, 80b) of an embodiment in which the repeating pattern is FFN. In warp path (80a), the termination zone is at (85a) and occurs over a distance of six CD threads. The two ends of the MD thread are attached to two CD fusible threads (90a, 95a) with two non-fusible CD threads and two fusible CD threads in between the two CD fusible threads (90a, 95a). In the adjacent warp path (80b), the termination zone is at (85b) and occurs over a distance of six CD threads. The two ends of the MD thread are attached to two CD fusible threads (90b, 95b), with two non-fusible CD threads and two fusible CD threads in between in between the two CD fusible threads (90b, 95b). As can be seen, the termination zones (85a, 85b) in successive warp paths (80a, 80b) actually overlap by three CD threads for the FFN pattern shown. Other termination zone patterns are possible for the FFN pattern. For example, successive termination zones can have two successive CD threads (with the sequence FF) in between.

FIG. 8 illustrates successive warp paths (81a, 81b) of an embodiment in which the repeating pattern is FFN. In warp path (81a), the termination zone is at (86a) and occurs over a distance of three CD threads. The two ends of the MD thread are attached to two CD fusible threads (91a, 96a), with one non-fusible CD thread in between the two CD fusible threads (91a, 96a.). In the adjacent warp path (81b), the termination zone is at (86b) and occurs over a distance of three CD threads. The two ends of the MD thread are attached to two CD fusible threads (91b, 96b), with one non-fusible CD thread in between in between the two CD fusible threads (91b, 96b). As can be seen, the termination zones (86a, 86b) in successive warp paths (81a, 81b) are separated by three CD threads for the FFN pattern shown. Other termination zone patterns are possible for the FFN pattern. For example, successive termination zones can have zero successive CD threads in between.

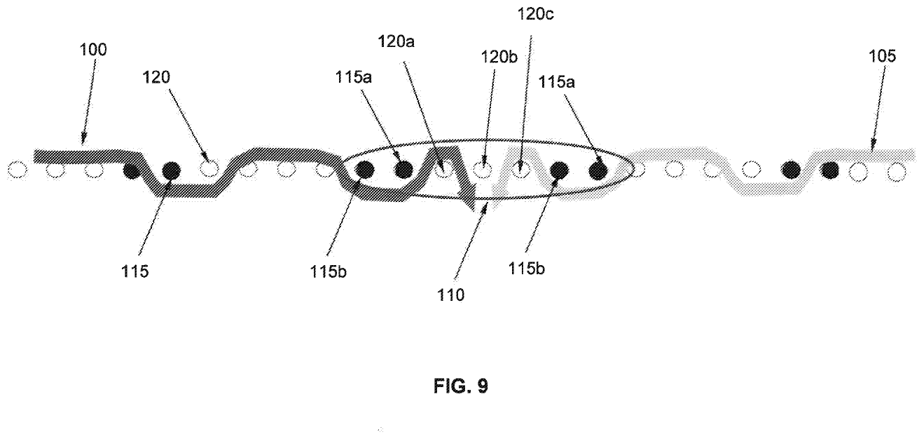

FIG. 9 illustrates another embodiment, in which two ends of an MD thread (100, 105) are woven through CD threads, and meet at a termination zone (110). The fusible (115) and non-fusible (120) CD threads are arranged in an FFNNNFFNNNN repeat pattern. In this embodiment, the termination zone (110) occurs over a breadth of seven CD threads Here, each of the two ends of the MD thread (100, 105) are attached to two fusible CD threads (115a, 115b), with three non-fusible CD threads (120a, 120b, 120c) in between the two CD fusible threads (115a, 115b). While FIG. 9 shows each end of the MD thread (100, 105) terminating without crossing over, it is possible for one or both ends of the MD thread (100, 105) to continue weaving with non-fusible CD thread (120b) and beyond. As an example, if laser welding is used to connect the ends of the MD thread (100, 105) to the fusible CD threads (115a, 115b) at termination zone (110) the ends of the MD thread (100, 105) are transparent to the wavelength of the laser used for laser welding, whereas the fusible CD threads (115a, 115b) absorb energy in the wavelength range of the laser used in laser welding.

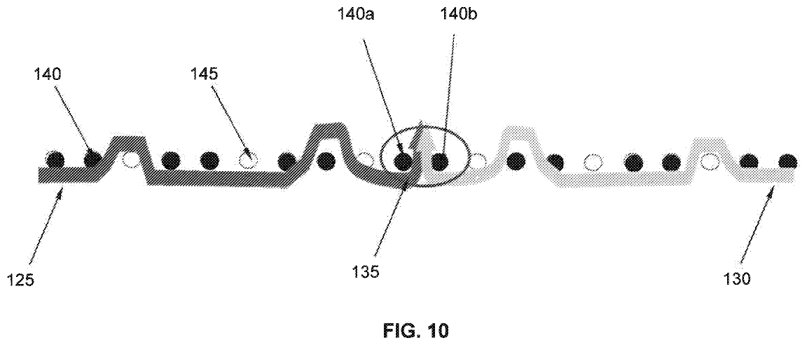

FIG. 10 illustrates another embodiment, in which two ends of an MD thread (125, 130) are woven through CD threads and meet at a termination zone (135). The fusible (140) and non-fusible (145) CD threads are arranged in an FNF repeat pattern. In this embodiment, the termination zone (135) occurs over a breadth of two CD threads (140a, 140b). Here, the two ends of the MD thread (125, 130) are attached to two fusible CD threads (140a, 140b) with no other CD threads in between the two CD fusible threads (140a, 140b). While FIG. 10 shows each end of the MD thread (125, 130) terminating without crossing over, it is possible for one or both ends of the MD thread (125, 130) to continue weaving with fusible CD threads (140a, 140b) and beyond. As an example, if laser welding is used to connect the ends of the MD thread (125, 130) to the fusible CD threads (140a, 140b) at termination zone (135), the ends of the MD thread (125, 130) are transparent to the wavelength of the laser used for laser welding, whereas the fusible CD threads (140a, 140b) absorb energy in the wavelength range of the laser used in laser welding.

FIG. 11 is a photograph of another embodiment of a seam region, in which the CD repeating unit is FNNFN. The fusible threads are shown as 155, with the non-fusible threads shown as 150.

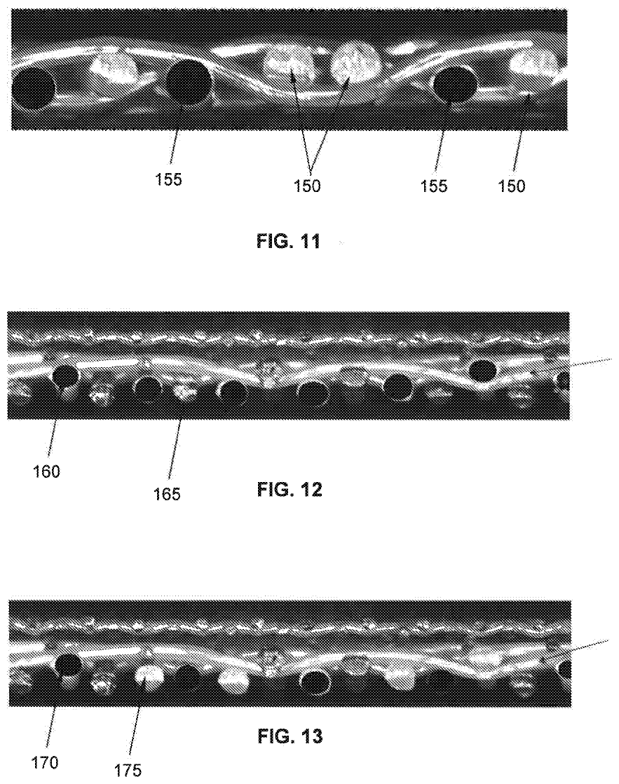

FIG. 12 is a photograph of an embodiment of a multilayer seam region. The fusible threads are shown as 160, with the non-fusible threads shown as 165. The machine side warp strand (shown with an arrow) weaves with CD threads of one layer that have a repeating pattern unit of FN. However, the overall multilayer structure has a repeating pattern unit of NNNNNF (one fusible CD thread out of every six CD threads).

FIG. 13 is a photograph of another embodiment of a multilayer seam region. The fusible threads are shown as 170, with the non-fusible threads shown as 175. The machine side warp strand (shown with an arrow) weaves with CD threads of one layer that have a repeating pattern unit of FNN. However, the overall multilayer structure has a repeating pattern unit of F (one fusible CD thread out of every twelve CD threads).

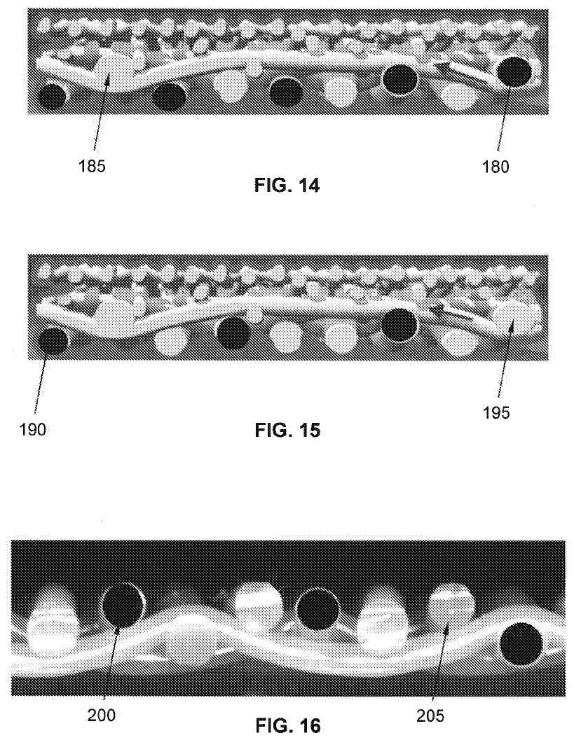

FIG. 14 is a photograph of another embodiment of a multilayer seam region. The fusible threads are shown as 180, with the non-fusible threads shown as 185. The machine side warp strand (shown with an arrow) weaves with CD threads of one layer that have a repeating pattern unit of FN. However, the overall multilayer structure has a repeating pattern unit of N NNNNNF (one fusible CD thread out of every eight CD threads).

FIG. 15 is a photograph of another embodiment of a multilayer seam region. The fusible threads are shown as 190, with the non-fusible threads shown as 195. The machine side warp strand (shown with an arrow) weaves with CD threads of one layer that have a repeating pattern unit of FNN. However, the overall multilayer structure has a repeating pattern unit of F (one fusible CD thread out of every twelve CD threads).

FIG. 16 illustrates another embodiment of a single layer seam, in which the CD repeating unit is FNN. The fusible threads are shown as 200, with the non-fusible threads shown as 205 in FIG. 16.

It will be appreciated by persons skilled in the art that the foregoing disclosure constitutes a description of specific embodiments showing how the seam may be applied and put into use. These embodiments are only exemplary and are not meant to limit the disclosure to what has been particularly shown and described herein above. A variety of modifications and variations are possible in light of the above teachings without departing from the scope of the present disclosure. The seam is further described and defined in the claims which now follow.

1. An endless fabric belt having a seam region, the seam region comprising:
a) machine direction (MD) threads;
b) cross-direction (CD) threads interwoven with the MD threads; and
c) termination zones distributed throughout the entire seam region, with each termination zone comprising two ends of an MD thread;
wherein:
a plurality of the CD threads are fusible, with the fusible (F) and non-fusible (N) CD threads distributed in a pattern throughout the seam region such that in a repeating unit of the pattern, the ratio of F threads to CD threads is at most 0.75; and
a plurality of the termination zones further comprise at least one fusible CD thread attached to the MD thread in the termination zone.

2. The belt of claim 1, wherein the ratio of F threads to CD threads in the repeating unit is at most 2:3.

3. The belt of claim 1, wherein the CD threads are fusible based on laser-weld technology, low-melt polymer technology, sheath-core technology or ultrasonic technology.

4. The belt of claim 1, wherein the MD and CD threads independently comprise a polymeric material.

5. The belt of claim 4, wherein the polymeric material is a polyamide or a polyethylene terephthalate.

6. The belt of claim 4, wherein the polymeric material is selected from the group consisting of polyphenylene sulfide (PPS), polybutylene terephthalate (PBT), polyurethane and polyethylene naphthalate (PEN).

7. The belt of claim 4, wherein the fusible CD thread further comprises an additive that permits fusing of the fusible CD thread based on laser-weld technology.

8. The belt of claim 7, wherein the additive is added in a range of from about 0.1 wt % to about 3 wt % of the weight of the CD thread.

9. The belt of claim 7, wherein the additive is added in a range of from about 0.3 wt % to about 1 wt % of the weight of the CD thread.

10. The belt of claim 6, wherein:
a plurality of the CD threads are fusible in a wavelength range of laser;
the MD threads are transparent to light of the wavelength range; and
at least some of the MD threads are laser-welded to the fusible CD threads by the laser.

11. The belt of claim 6, wherein the fusible CD threads comprise carbon.

12. The belt of claim 11, wherein the fusible CD thread comprises carbon black.

13. The belt of claim 1, wherein there is at least one non-fusible CD thread in between two fusible CD threads in the repeating unit of the pattern.

14. The belt of claim 1, wherein the seam region is a single layer weave, and the repeating unit of the patter is FN.

15. The belt of claim 1, wherein the seam region is a single layer weave, and the repeating unit of the pattern is FFNNNFFNNNN.

16. The belt of claim 1, wherein the seam region is a single layer weave, and the repeating unit of the pattern is FNN.

17. The belt of claim 1, wherein the seam region is a single layer weave, and the repeating unit of the pattern is FNFNNN.

18. The belt of claim 1, wherein the seam region is a multilayer weave, and an overall repeating unit of the pattern is FNNNNN.

19. The belt of claim 1, wherein the seam region is a multilayer weave, and an overall repeating unit of the pattern is FNNNNNNNNNN.

20. The belt of claim 1, wherein the seam region is a multilayer weave, and an overall repeating unit of the pattern is FNNNNNNN.

21. The belt of claim 1, wherein the termination zone comprises weaving of at least one of the MD thread ends with one or more CD threads.
